(19) United States
(12) Patent Application Publication
(10) Pub. No.: US 2006/0288493 A1
(43) Pub. Date: Dec. 28, 2006

(54) Process For Producing Leather Footwear Lining

(75) Inventor: Franciscus Cornelis Marie Metsaars, Whitehall, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: Wolverine World Wide, Inc., Rockford, MI (US)

(21) Appl. No.: 11/458,846

(22) Filed: Jul. 20, 2006

Related U.S. Application Data
(63) Continuation-in-part of application No. 11/166,760, filed on Jun. 24, 2005.

(51) Int. Cl. C14C 11/00

(52) U.S. Cl. 8/94.2

(57) ABSTRACT

A method for producing leather well-suited for use as a lining material for footwear including the steps of (a) providing wet blue, full grain skins, (b) applying a degreasing and emulsifying agent to the skins, (d) neutralizing the skins to provide the skins with a pH level of about 7.0 of greater, (e) applying a waterproofing agent to the skins, (f) applying a tanning agent to the skins, (g) fixing the waterproofing agent and tanning agent in the skins by introducing an acid to reduce the pH level to a range of between approximately 3.0 to 3.5, (h) applying an antimicrobial treatment to the skins, (i) applying a waterproofing agent to the skins, (j) applying a leather protectant to the skins, (k) fixing the skins by introducing an acid to reduce the pH level to the range of between approximately 3.0 and 3.5.

This application is a continuation-in-part of U.S. application Ser. No. 11,166,760, which was filed on Jun. 24, 2005, by Franciscus Cornelis Marie Metsaars.

### BACKGROUND OF THE INVENTION

The present invention relates to methods for the production of leather, and more particularly to a process for producing leather suitable for use as a lining material in footwear.

Leather is used in a wide variety of applications. One of the most common uses of leather is in footwear. In the context of footwear, leather may be used to form nearly every element of the article of footwear. For example, the upper, sole and even the laces may be manufactured from leather. Leather may also be used to form a lining material for the article of footwear. In this context, a layer of leather may sewn or other be used to line the inside of the upper to provide a comfortable surface to engage the wearer's foot. Leather lining materials are typically soft and supple while at the same time being relatively durable.

It is often desirable to provide waterproof footwear. Waterproof footwear is used in variety of settings, such as hunting, fishing, hiking and other outdoor applications. One conventional technique for manufacturing waterproof footwear is to form a waterproof bootie that is removably fitted inside the upper. A conventional bootie is shaped much like a sock and is intended to fit snuggly within the upper and snuggly around the wearer's foot. These booties can be relatively expensive to manufacture and may adversely affect the comfort and weight of the article of footwear. They can also be inconvenient to use because they can be pulled from inside the boot when the wearer's foot is removed, thereby requiring repeated reinsertion. Another conventional technique for manufacturing waterproof footwear is to form the upper from a material that is waterproof and sufficiently durable for the intended application. This type of manufacture is complicated by the need to use relatively complex techniques for providing a waterproof seam or interface between the upper material and the sole.

Despite the widespread use of leather in footwear construction, the prior art is devoid of a leather tailored for use as waterproof footwear lining material. Leather production is a complex process in which efforts to enhance one desirable characteristic of the leather can have an unanticipated negative impact on other desired characteristics of the leather. As likely the result of the complexities associated with leather manufacture, there remains an unmet need for a waterproof and antimicrobial leather that is sufficiently soft, supple are durable enough to function as a lining material for footwear.

### SUMMARY OF THE INVENTION

The aforementioned problems are overcome by the present invention wherein a process is provided for producing a lightweight leather that is waterproof and breathable. The material also includes antimicrobial characteristics and is highly perspiration resistant and colorfast. The production process generally includes the steps of: (a) providing wet blue, full grain skins, (b) applying a surfacant/degreasing agent to the skins, (c) applying an emulsifying agent to the skins, (d) neutralizing the skins to provide the skins with a pH level of in the range of about 7.0 or greater, (e) applying a waterproofing agent to the skins, (f) applying a tanning agent to the skins, (g) fixing the waterproofing agent and tanning agent in the skins without chrome or other metal salts while reducing the pH level to within the range of about 3.0 to 3.5, (h) applying an antimicrobial treatment to the skins, (i) applying a waterproofing agent to the skins, (j) applying a leather protectant to the skins and (k) fixing the skins without chrome or other metal salts while moving the pH level to within the range of about 3.0 to 3.5. If desired, the skins can also be subjected to additional treatments, such as flame resistant/flame proof treatments.

In one embodiment, the step of applying a waterproofing agent to the skins is further defined as applying both a silicone-based waterproofing agent and a paraffin-based waterproofing agent to the skins. In one embodiment the paraffin-based waterproofing agent is applied to the skins first and the silicone-based waterproofing agent is applied second. In another embodiment, the second step of applying a waterproofing agent to the skins includes applying a silicone-based waterproofing agent to the skins.

In one embodiment, the antimicrobial treatment and leather protectant are applied to the skins in a fluorchemical process. In another embodiment, the second step of applying a waterproofing agent is also carried out in fluorchemical process.

The present invention produces a breathable, yet water protective leather. The leather is lightweight and comfortable, yet durable to provide a long lasting lining material. The leather has desirable perspiration resistance, which among other things resists color transfer to other materials, such as the wearer's sock. The leather protectant step also provides the leather with a high degree of stain/oil resistance. The antimicrobial treatment also provides the leather with highly desirable anti-fungal characteristics. As a result of these characteristics, the process is particularly well-suited for use in producing leather to be use as a waterproof lining for footwear.

These and other objects, advantages, and features of the invention will be readily understood and appreciated by reference to the detailed description of the preferred embodiment and the drawings.

### BRIEF DESCRIPTION OF THE DRAWINGS

FIG. 1 is a flow chart showing the general steps of the present invention;

FIG. 2 is a flow chart showing the general steps of the degreasing and neutralizing phases;

FIG. 3 is a flow chart showing the general steps of the waterproofing phase;

FIG. 4 is a flow chart showing the general steps of the retanning phase;

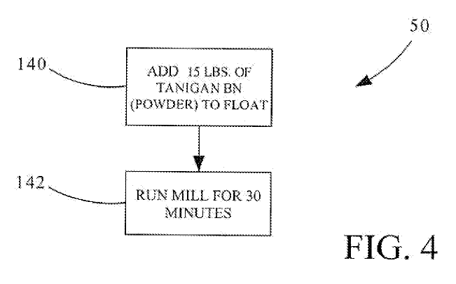

FIG. 5 is a flow chart showing the general steps of the first fixing phase;

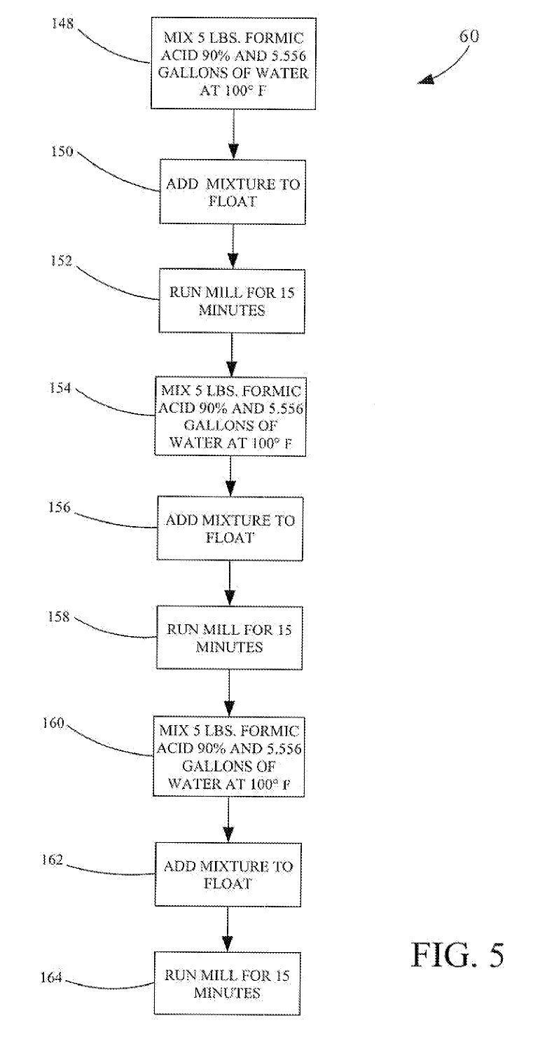

FIG. 6 is a flow chart showing the general steps of the fluorchemical phase; and

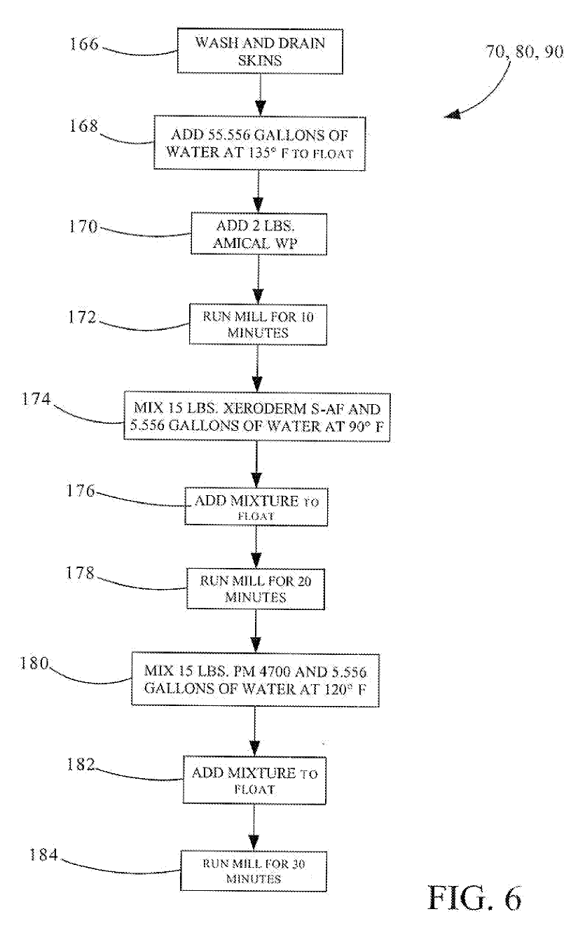

FIG. 7 is a flow chart showing the general steps of the second fixing phase.

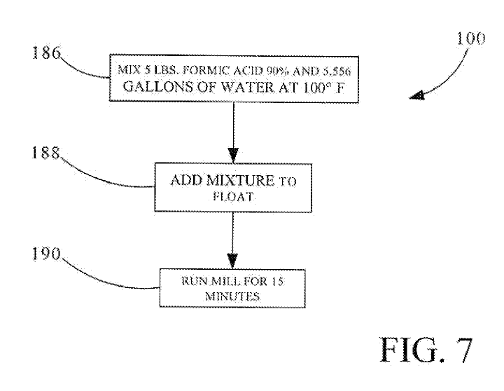

### DETAILED DESCRIPTION OF THE PREFERRED EMBODIMENT

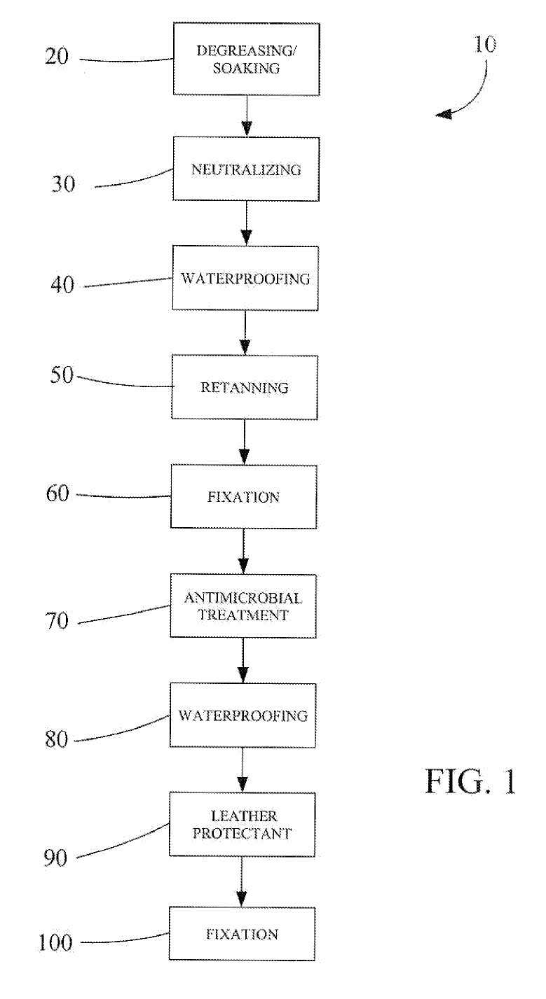

An embodiment of the present invention is described in connection with the flowchart of FIG. 1. As shown in FIG. 1, the present method 10 generally includes the steps of (a) degreasing and soaking the skins 20, (b) neutralizing the skins 30, (c) waterproofing the skins 40, (d) retanning the skins 50, (d) fixing the skins 60, (f) applying an antimicrobial treatment 70, an additional waterproofing agent 80 and a leather protectant 90 to the skins and (g) fixing the skins 100 a second time. Together, these steps provide waterproof leather that is particularly well-suited for use as a lining material for footwear. The method is particularly well-suited for use in treating wet blue pig skins, but can be used in whole or in part to treat other skins as well. In some applications, the process may require routine modification to provide optimal results depending, for example, on the type and specific characteristics of the skins to be treated and on the specifically desired characteristics of the finished leather. The manner and degree of any such modifications will be readily apparent to those skilled in the art.

The following description sets forth an embodiment of the present invention that is optimized to provide finished leather with a particular set of desired characteristics. Those skilled in the field will readily appreciate that the specified times and quantities are approximate and that some variation in a specified time or in a specified quantity will typically yield acceptable results in the finished leather, and adjustments can be used to intentionally adjust the characteristics of the finished leather. The amount of acceptable variation in a particular time or quantity will vary depending primarily on the amount of acceptable variance in the finished leather. For example, variations in the range of approximately ±20% in the quantity of a particular additive are likely to be acceptable for each of the additives, except for the acidic and caustic materials used to adjust the pH level of the float (i.e. formic acid, sodium formate, sodium bicarbonate and aqua ammonia). However, even with the acidic and caustic materials, variation in the quantity of a particular additive may be compensated for by adjustment in the strength (e.g. percent of composition) of the additive or in time that the mill is run with the additive in the float provided that the specified pH levels are obtained. It should further be noted that, in the following paragraphs, the percentages of various additives are specified in parentheses following the specified weight or volume quantities. These percentages refer to the weight of the additive with respect to the total weight of the wet blue skins being processed. Additionally, unless specifically set forth in the claims, the order of steps set forth in this description is intended to be exemplary and is not intended to require the steps of the present invention to be performed in any specific order.

In the illustrated embodiment, the process begins by loading the wet blue skins into a conventional mill. In this embodiment, approximately 500 lbs. of skins are loaded into the mill. Typically, the wet blue skins have a pH of 3.5 or lower. As a first step, the skins may be washed. Initially, approximately 400 gallons of water are added to the mill. The water may be at a temperature of approximately 140° Fahrenheit (F.), but the temperature may vary, for example, between 105°-150° F. The skins are washed and then the water is drained from the mill.

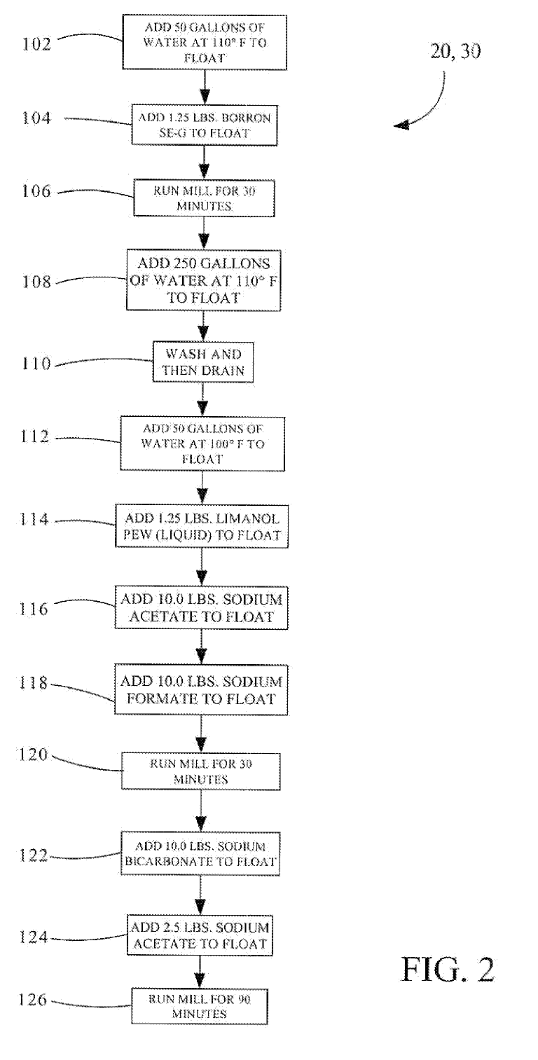

After the initial washing step, the skins undergo the degreasing and neutralizing phase 20, 30 (See FIG. 2). In this embodiment, the two phases are carried out somewhat together. This phase begins by adding 102 approximately 50 gallons of water to the mill to create the float. The water is preferably at a temperature of approximately 110° F., but the temperature may vary, for example, between 90°-120° F. Following this, a degreasing agent is added 104 to the mill. In this embodiment, approximately 1.25 lbs. (or 0.25%) of Borron SE-G (available from TFL USA/Canada Ltd.) is added to the mill through the door. Borron SE-G is a nonionic, degreasing and emulsifying agent, which degreases the skins and prepares them to receive further treatments. The Borron SE-G can be replaced by other degreasing/emulsifying agents, as desired. The mill is run 106 for approximately 30 minutes, but the running time may vary, for example, between 20-60 minutes.

Following these steps, the skins are washed and neutralized 30 (See FIG. 2). In the illustrated embodiment, this process includes three stages. In the first stage, the skins are washed by adding 108 approximately 250 gallons of water to the mill at approximately 110° F., but the temperature may vary, for example, between 90-120° F. The mill is run and then drained 110.

In the second stage, 50 gallons of water is added 112 to the mill to establish the float. The water is preferably at a temperature of approximately 110° F., but the temperature may vary, for example, between 90-120° F. Following this, approximately 1.25 lbs. of Limenal PEW, 10.0 lbs. of sodium acetate (or 2%) is added 114 to the mill and 10.0 lbs. of sodium formate (or 2%) is added 116 to the mill. The mill is then run 120 for approximately 30 minutes. Limenal PEW is an emulsifying agent, and it may be replaced by other emulsifying agents of corresponding amounts.

In the third stage, approximately 10.0 lbs. of sodium bicarbonate (or 2%) is added 122 to the mill and 2.5 lbs. of sodium acetate (or 0.5%) is added 124 to the mill. The mill is then run 126 for approximately 90 minutes. The mill running time may vary, for example, between 90-120 minutes. The process is likely to provide the skins with a pH value of approximately 7.0 or higher.

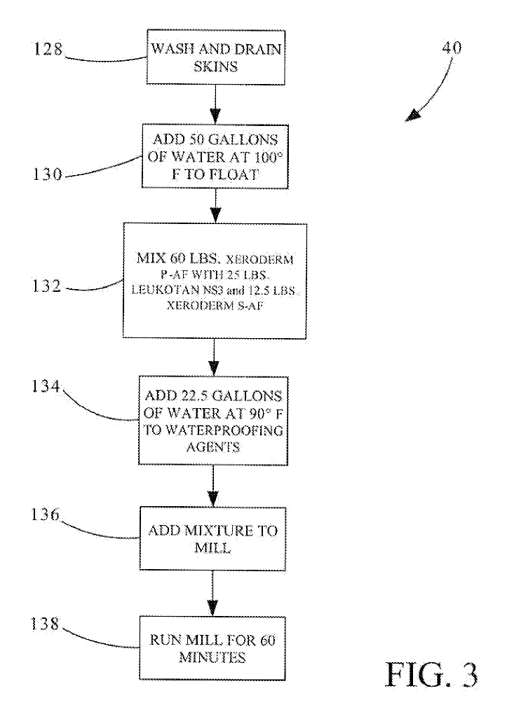

The neutralized skins are next subjected to the waterproofing phase 40 (See FIG. 3). To prepare for the waterproofing phase, approximately 500 gallons of water at approximately 120° F. are added to the mill, and the skins are washed and drained 128. The temperature of the water may vary, for example, between 90-130° F. After the skins have been washed and drained, approximately 50 gallons of water is added 130 to the mill to create the float. The water may be at a temperature of approximately 100° F., but vary, for example, in a range of 70-105° F. Then, approximately 60 lbs. (or 12%) of Xeroderm P-AF (available from Lanxess (formerly Bayer) of Pittsburgh, Pa.), approximately 25 lbs. (5%) of Leukotan NS3 (available from Rohm & Haas of Philadelphia, Pa.) and approximately 12.5 lbs. (or 2.5%) of Xeroderm S-AF (available from Lanxess (formerly Bayer) of Pittsburgh, Pa.) are mixed 132. Xeroderm P-AF, Leukotan and Xeroderm S-AF are waterproofing agents that have proven to be well-suited for use in this application. Xeroderm P-AF is a polymer-based material, while Xeroderm S-AF is a silicone-based material. These chemicals may be replaced by other waterproofing agents in alternative applications. Although this embodiment incorporates a polymer-based waterproofing agent (i.e. Xeroderm P-AF), the polymer-based material may be replaced by a paraffin-based material or by a combination of polymer-based and paraffin-based materials. Afterwards, approximately 22.5 gallons of water are combined 134 with the waterproofing agents, and the mix is added 136 to the mill. This water may be at a temperature of approximately 90° F., but its temperature may vary. The mill is then run 138 for approximately 60 minutes. The running time of the mill may vary, for example, between 30 to 90 minutes.

The skins next undergo a retanning process 50. In the desired embodiment, approximately 15.0 lbs. of Tanigan BN (or 3%) is added 140 to the mill and the mill is run 142 for approximately 30 minutes. Tanigan BN is synthetic tanning agent available from (available from Lanxess (formerly Bayer) of Pittsburgh, Pa.). This synthetic tanning agent may be replaced by other tanning agents—natural or synthetic.

The skins next pass into the fixation phase 60. To aid in fixing the waterproofing agents and retanning agent in the skins, formic acid is added to the mill in two sequential installments. First, approximately 5.0 lbs. (1%) of formic acid (90% concentration) is mixed 148 with approximately 5.556 gallons of water at approximately 100° F. The mixture is added 150 to the mill. The mill is run 152 for approximately 15 minutes. The runtime of the mill may vary, for example, between 10 to 40 minutes. Then, a second installment of approximately 5.0 lbs. (1%) of formic acid (90% concentration) and 5.556 gallons of water at approximately 100° F. are mixed 154 and added 156 to the mill. The mill is then run 158 for approximately 15 minutes. Finally, a third installment of approximately 5.0 lbs. (1%) of formic acid (90% concentration) and 5.556 gallons of water at approximately 100° F. are mixed 160 and added 162 to the mill. The mill is again run 164 for approximately 15 minutes. The runtime of the mill may vary, for example, between 10 to 40 minutes. This should bring the skins to a pH level below approximately 3.5.

The skins are next subjected to a fluorchemical process 70 in which an antimicrobial agent, a leather protectant and a waterproofing agent are introduced to the skins. To prepare for this process, the skins are washed 166 in approximately 1000 gallons of water at approximately 135° F., and the mill is drained. The temperature of the water may vary, for example, between 115 to 150° F. The fluorchemical process begins by adding 168 approximately 55.556 gallons of water at approximately 135° F. to the mill to establish the float. Next, approximately 2.0 lbs. (0.4%) of Amical WP is dry fed 170 into the mill, and the mill is run 172 for approximately 10 minutes. Amical WP is a conventional antimicrobial treatment that is available from Chemtan Company, Inc. of Exeter, N.H. This additive may be replaced or supplemented with other antimicrobial agents. The runtime of the mill may vary, for example, between 10 to 20 minutes. Following this step, the skins are subjected to a second waterproofing phase 80. In this phase, approximately 15.0 lbs. (3%) of Xeroderm S-AF (available from Lanxess (formerly Bayer) of Pittsburgh, Pa.) is mixed 174 with approximately 5.556 gallons of water at approximately 90° F. The mixture is added 176 to the mill. The mill is run 178 for approximately 20 minutes. The runtime of the mill may vary, for example, between 10 to 30 minutes. After, the skins undergo a leather protectant phase 90. In this phase, approximately 15.0 lbs. (3%) of PM 4700 is mixed 180 with approximately 5.556 gallons of water at approximately 120° F. The mixture is added 182 to the mill, and the mill is run 184 for approximately 30 minutes. The runtime of the mill may vary, for example, between 20 to 60 minutes. The PM 4700 is a conventional leather protectant that renders the skins oil resistant and water resistant, and is available from 3M under the trade name “Scotch Guard®.” This protectant can be replaced or supplemented by other conventional protectants, if desired.

The skins are next treated to fix 100 the various agents in the skins. Approximately 5.0 lbs. (1%) of formic acid (90% concentration) is mixed 186 with approximately 5.556 gallons of water at approximately 100° F. The mixture is added 188 to the mill. The mill is run 190 for approximately 15 minutes. The runtime of the mill may vary, for example, between 5 to 45 minutes). These steps should bring the skins to a pH level in the range of 3.0 to 3.5.

If desired, additional treatments may be applied to the skins. For example, antistatic, flame resistant or flame proof treatments may be applied. The flame resistant or flame proof treatment may be applied to the skins in a dry or dissolved state, as desired. Further, additional antimicrobial treatments may be applied. Additional antimicrobial treatments may also be applied in a dry or dissolved state.

Next, the skins are subjected to a final washing. Approximately 1000 gallons of water at 100° F. are added to the mill while the mill is running. The washing door of the mill may be left open, permitting the water to slosh from the mill. The mill is run until nearly all of the water has sloshed from the mill. Then, the skins or leathers are dumped from the mill.

The leathers are preferably dried using conventional vacuum dryers or other similar machinery. The dried leathers can be staked and finished as desired. Staking is a mechanical softening process that typically involves beating the leather repeatedly with small fingers. The leathers can also be sanded and milled, as appropriate. The leathers can undergo additional finishing, as desired. For example, oil can be applied to the leather to add to waterproofness and change the look and feel of the leather. In the described embodiment, the finished leather may have a thickness ranging between 0.8 to 1.0 millimeters, which corresponds to a weight of approximately 2.0 to 2.5 ounces.

The above description is that of a preferred embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A method for producing leather from skins, comprising the steps of:
applying a degreasing/emulsifying agent to the skins;
neutralizing the skins by raising the pH level of the skins to at least approximately 7.0 or above;
applying a waterproofing agent to the skins after said neutralizing step;
applying a tanning agent to the skins;
fixing the skins a first time after said waterproofing step and said tanning step by introducing acid to the skins to lower the pH level of the skins below approximately 3.5;
applying a leather protectant to the skins with the skins; and
fixing the skins a second time after said antimicrobial step and after said leather protectant step by introducing acid to the skins to lower the pH level of the skins below approximately 3.5.

2. The method of claim 1 further comprising the step of applying an antimicrobial treatment to the skins after said first fixing step and before said second fixing step.

3. The method of claim 2 further comprising the step of applying a waterproofing agent to the skins after said first fixing step and before said second fixing step.

4. The method of claim 3 further comprising the step of washing the skins after said first fixing step and before said leather protectant step.

5. The method of claim 4 wherein said first waterproofing step includes the steps of:
applying at least one of a paraffin-based waterproofing agent and a polymer-based waterproofing agent to the skins; and
applying a silicone-based waterproofing agent to the skins.

6. The method of claim 5 further comprising the step of washing the skins after said neutralizing step and before said first waterproofing step.

7. The method of claim 6 wherein said second waterproofing step is further defined as applying a silicone-based waterproofing agent to the skins.

8. The method of claim 7 wherein the waterproofing agents are mixed together and then combined with water at temperature of approximately 90° F. before introduction to the skins.

9. The method of claim 8 wherein said step of neutralizing the skins is performed in a float of water at approximately 110° F.

10. A method for producing leather from skins for use as a lining material in footwear, comprising the steps of:
introducing the skins into a mill;
neutralizing the skins by introducing a base into the mill to raise the pH level of the skins to approximately 7.0 or greater;
applying at least one of a paraffin-based waterproofing agent and a polymer-based waterproofing agent to the skins by introducing the waterproofing agent into the mill after said neutralizing step;
applying a silicone-based waterproofing agent to the skins by introducing the waterproofing agent into the mill after said neutralizing step;
fixing the waterproofing agents by introducing an acid into the mill to lower the pH level of the skins to within a range of approximately 3.0 to 3.5;
applying an antimicrobial material to the skins by introducing the antimicrobial material to the mill;
applying a leather protection to the skins by introducing the leather protectant to the mill; and
fixing the antimicrobial material and the leather protectant within the skins by introducing as acid into the mill to provide the skins with a pH level within a range of approximately 3.0 to 3.5.

11. The method of claim 10 further comprising the step of applying a waterproofing agent to the skins after said first fixing step and before said second fixing step.

12. The method of claim 11 further comprising the step of washing the skins after said first fixing step and before said leather protectant step.

13. The method of claim 12 further comprising the step of washing the skins after said neutralizing step and before said first waterproofing step.

14. The method of claim 13 wherein said second waterproofing step is further defined as applying a silicone-based waterproofing agent to the skins by introducing a silicone-based waterproofing agent to the mill.

15. The method of claim 14 further including the steps mixing the waterproofing agents together with water at temperature of approximately 90° F. before introduction to the skins.

16. The method of claim 13 wherein said step of neutralizing the skins is performed in a float of water at approximately 110° F.

17. The method of claim 13 further comprising the step of retanning the skins by introducing a tanning agent into the mill after said first waterproofing step and before said first fixing step.

18. A method for producing a leather lining material for use in footwear from pig skins, comprising the steps of:
introducing wet blue pig skins into a mill containing a float of water, the skins having a weight;
applying at least one of a degreasing agent and an emulsifying agent to the skins by introducing at least one of a degreasing agent and an emulsifying agent into the water and running the mill for at least approximately thirty minutes, the degreasing agent having a weight of approximately 0.25% percent of the weight of the skins;
neutralizing the skins by introducing a base into the water and running the mill to bring the pH level of the skins to approximately 7.0 or above;
waterproofing the skins by introducing a silicone-based waterproofing agent and at least one of a paraffin-based waterproofing agent and a polymer-based waterproofing agent into the water and running the mill for at least approximately 60 minutes, the at least one of a paraffin-based waterproofing agent and a polymer-based waterproofing agent having a weight of approximately 12 percent of the weight of the skins, the silicone-based waterproofing agent having a weight of approximately 2.5 percent of the weight of the skins;
fixing the waterproofing agents in the skins by introducing an acid into the water and lowering the pH level to a range between approximately 3.0-3.5;
applying an antimicrobial treatment to the skins by introducing an antimicrobial material into the water, the antimicrobial material having a weight of at least approximately 0.4% of the weight of the skins;
applying a leather protectant to the skins by introducing the leather protectant into the water, the leather protectant having a weight of at least approximately 3% of the weight of the skins; and
fixing the antimicrobial material and the leather protectant within the skins by introducing an acid into the water and bringing the pH level of the skins to a range between approximately 3.0 and 3.5.

19. The method of claim 18 further comprising the step of applying a tanning agent to the skins after said waterproofing step by introducing a tanning agent to the water, the tanning agent having a weight of approximately 3.0% of the weight of the skins.

20. The method of claim 19 further comprising the step of applying a waterproofing agent to the skins after said first fixing step and before said second fixing step, the waterproofing agent being a silicone-based waterproofing agent and having a weight of approximately 3% of the weight of the skins.
